(19) United States
(12) Patent Application Publication
(10) Pub. No.: US 2026/0309226 A1
(43) Pub. Date: Oct. 8, 2026

(54) PARK LOCK DEVICE HAVING A SPRING-GUIDING MEANS

(71) Applicant: SCHAEFFLER TECHNOLOGIES AG & CO. KG, Herzogenaurach (DE)

(72) Inventors: Uwe Schwarz, Erlangen (DE); Ulli Schwab, Rohr (DE); Klaus Krämer, Herzogenaurach (DE)

(73) Assignee: SCHAEFFLER TECHNOLOGIES AG & CO. KG, Herzogenaurach (DE)

(21) Appl. No.: 19/482,782

(22) PCT Filed: Apr. 10, 2024
(86) PCT No.: PCT/DE2024/100297

§ 371 Date: Nov. 10, 2025

(30) Foreign Application Priority Data
May 11, 2023 (DE) 10 2023 112 433.1

(51) Int. Cl. F16H 63/34

(52) U.S. Cl. CPC F16H 63/3433

(57) ABSTRACT

The invention relates to a park lock device (10) comprising: a pivotable pawl (12) which can be pivoted between a locking position (20) in which the pawl (12) form-lockingly engages in a rotary component and a release position in which the pawl (12) is uncoupled from the rotary component; a slide (30) which can be moved relative to a support element (26) in the axial direction (28) such that the axial position of the slide is changed and which, in a first axial position (32), deflects the pawl (12) into the locking position (20); a spring element (46) which is coupled, at one end, to the support element (26) and, at the other end, to the slide (30) and
which applies a spring force to the slide (30) when the slide (30) is in at least one of its axial positions (32); a spring-guiding means (60) which positions the spring element (46) on the slide (30) with respect to at least one direction (62) perpendicular to the axial direction (28), wherein an axial length (66) of the spring-guiding means (60) in the axial direction (28), proceeding from the slide (30) toward the support element (26), is less than a minimum spring length (70) of the spring element (46) in the axial direction (28).

### CROSS-REFERENCE TO RELATED APPLICATIONS

This application is the United States National Phase of PCT Appln. No. PCT/DE2024/100297 filed Apr. 10, 2024, which claims priority to German Application No. DE102023112433.1 filed May 11, 2023, the entire disclosures of which are incorporated by reference herein.

### TECHNICAL FIELD

The present disclosure relates to a park lock device.

### BACKGROUND

DE 10 2018 130 765 A1 describes a park lock device having a pawl which is actuated via a slide and pivotably mounted on a bolt about an axis of rotation. A spring element is positioned on the slide via a guide rod. The slide is operatively connected to the pawl and can be moved axially in the longitudinal direction of the guide rod to actuate the pawl. A support element is designed to guide the guide rod and to accommodate the spring element. A further park lock device with a slide is known from WO 2020/103 970 A1.

### SUMMARY

The present disclosure provides a park lock device with a reduced mass inertia of the slide and the components connected thereto and movable in the axial direction.

The disclosed park lock device can be implemented in a more reliable and robust manner. The material stress at the interface between the spring-guiding means and the slide can be reduced. The mass inertia of the components that can be moved axially with the slide can be reduced. A commonly used guide rod can be eliminated.

The park lock device can be arranged in a vehicle. The vehicle can be a motor vehicle. The vehicle can be an electric vehicle. The park lock device can be connected to a transmission. The park lock device can be arranged in or on the transmission.

The park lock device restricts or prevents movement of the vehicle from a parked position when in the locking position. For example, a vehicle on a slope can be prevented from moving. The rotary component can be rotated freely in the release position by the park lock device.

The rotary component can be a locking ring or a park lock wheel. The rotary component can be connected to a transmission shaft of the transmission. The rotary component can have a locking toothing, in particular arranged on an outer circumference. In the locking position, the pawl can form-lockingly engage in the locking teeth. The pawl may have a pawl tooth which is form-lockingly connected to the locking teeth in the locking position.

The slide can be moved in the axial direction by an actuator element. The actuator element can change the axial position of the slide. The actuator element can have an electric motor, in particular a servomotor. The actuator element can be connected to an electric motor as a drive element. The actuator element and the spring element can be arranged coaxially. The actuator element can be arranged at an angle relative to the spring element, for example at an angle from 2° to 6°, e.g., 4° or 5°.

The slide can allow and/or adjust the release position of the pawl in a second axial position that differs from the first axial position, in particular by actuating the pawl.

The spring element can be connected to the spring-guiding means by means of a press fit.

The minimum spring length can be achieved when the spring element is compressed to its maximum.

The support element can be firmly connected to a park lock housing, in particular a reinforcing plate and/or lateral plate. The support element can be made of plastic. The park lock device can be firmly connected, in particular screwed, to a transmission housing of the transmission via the park lock housing. The park lock device can support a supporting force of the pawl in the locking position on the transmission housing via the park lock housing.

The spring-guiding means can be designed as a bore in the slide, for example in a housing wall, which receives the spring element. A slide housing may include the housing wall.

The spring-guiding means can be contact-free in all axial positions of the slide relative to the support element.

The spring-guiding means positions the spring element on the slide by fixing the spring element to the slide with or without play. In the case of a positioning with play, a limited mobility of the spring element in the relevant direction relative to the slide is possible. The spring-guiding means may position the spring element on the slide in at least one further direction which is again perpendicular to the axial direction and the direction perpendicular thereto, e.g., in all directions perpendicular to the axial direction. The spring-guiding means can also fix the spring element to the slide in the axial direction.

The spring element can be connected to the spring-guiding means in a form-locking, force-locking and/or frictional manner. The spring element can be pressed or snapped onto the spring-guiding means.

In an example embodiment, the axial length of the spring-guiding means may be smaller than a minimum distance in the axial direction between the slide and the support element. The minimum distance can be at the second axial position. The minimum distance can be that between a component of the slide receiving or having the spring-guiding means, for example a transverse plate, and the support element. The minimum distance may be that between a section of the support element receiving the spring element and the slide, in particular the component of the slide.

In an example embodiment, it is provided that the spring-guiding means and the spring element overlap at least in sections in the axial direction. The axial length may be less than 30%, in particular less than 20% of the spring length.

In an example embodiment, the spring element may be designed as a helical spring having a plurality of spring coils. The helical spring may have more than 5, e.g., more than 10 or more than 15 spring coils. The number of spring coils can be selected depending on a required spring rate, wire diameter and/or spring diameter.

In an example embodiment, the spring-guiding means may be arranged inside an inner spring diameter of the spring element. The spring-guiding means may have a width that is greater than or equal to an inner spring diameter. This allows the spring element to rest securely against the spring-guiding means, in particular to be pressed on.

In an example embodiment, the spring-guiding means may be arranged outside of an outer spring diameter of the spring element. The spring-guiding means can enclose at least one spring coil. The spring-guiding means can be oval or round.

In an example embodiment, the support element may have a receptacle, on the inner circumference of which an outer spring diameter of the spring element may bear for positioning on the support element with respect to at least one direction perpendicular to the axial direction. The receptacle can be designed as a bore in the support element.

Alternatively, the support element may have a projection on which the spring element is positioned.

In an example embodiment, the receptacle may accommodate at least half of the total spring coils of the spring element. This prevents the spring element from buckling in a direction deviating from the axial direction.

In an example embodiment, the spring-guiding means may be a separate component from the slide and may be attached thereto. The spring-guiding means can be designed as a pin. The spring-guiding means can be connected to the slide in a form-locking, frictional, and/or materially bonded manner.

In an example embodiment, the spring-guiding means may be designed in one piece with the slide. The spring-guiding means can be designed in one piece from a slide housing, e.g., a housing wall of the slide housing. The spring-guiding means can be a through-hole, in particular through the housing wall.

Further advantages and example embodiments are apparent from the description of the figures and the drawings.

### BRIEF DESCRIPTION OF THE FIGURES

The present disclosure is described in detail below with reference to the drawings. In the drawings, in particular:

FIG. 1 shows a cross-section of a park lock device in an example embodiment.

FIG. 2 shows a slide housing of a slide of the park lock device shown in FIG. 1.

FIG. 3 shows a cross-section of a park lock device in a further embodiment.

FIG. 4 shows a slide housing of a slide of the park lock device shown in FIG. 3.

FIG. 5 shows a cross-section of a housing wall of the slide housing shown in FIG. 4.

FIG. 6 shows the slide housing shown in FIG. 4 with a partially visible spring element.

FIG. 7 shows a three-dimensional view of a park lock device in a further embodiment.

### DETAILED DESCRIPTION

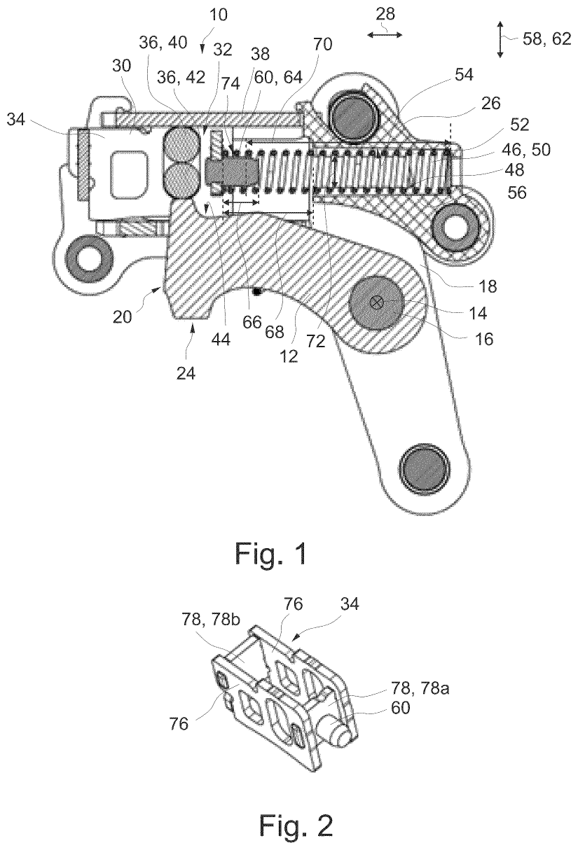

FIG. 1 shows a cross-section of a park lock device in an example embodiment. The park lock device 10 includes a pawl 12 which can be pivoted about an axis of rotation 14. The pawl 12 is pivoted on a reinforcing plate 18 via a bolt 16. In a locking position 20 shown here, in which a pawl tooth 24 of the pawl 12 form-lockingly engages in a rotary component (not shown here), a rotary movement of the rotary component, for example a park lock wheel, is blocked.

In a release position, the pawl 12 is uncoupled from the rotary component. The pawl 12 is preloaded to assume the release position by a return spring (not shown here).

The park lock device 10 also includes a slide 30 which is displaceable in the axial direction 28 relative to a support element 26 and which, in a first axial position 32 shown here, deflects the pawl 12 into the locking position 20 and, in a second axial position, allows the release position of the pawl 12, in which the pawl 12 is rotated about the bolt 16 and is deflected upwards relative to the rotary component. The slide 30 includes a slide housing 34 in which at least two support rollers 36 are arranged, which impart a supporting force between the pawl 12 and a support plate 38 connected to the reinforcing plate 18. A support roller 40 can roll on the support plate 38 and a further support roller 42 can roll on an outer contour 44 of the pawl 12. The supporting force between the pawl 12 and the support plate 38 is thus transferred via the support roller 40 to the further support roller 42.

The park lock device 10 includes a spring element 46 which is coupled, at one end, to the support element 26 and, at the other end, to the slide 30 and which, in at least one of the axial positions of the slide 30, in particular the second axial position, applies a spring force to the slide 30 in the direction of the first axial position 32. The spring element 46 is designed as a helical spring 50 having a plurality of spring coils 48.

The support element 26 is firmly connected to the reinforcing plate 18. The support element 26 has a receptacle 52 in which the spring element 46 is received in sections and on the inner circumference 54 of which the outer spring diameter 56 of the spring element 46 bears for positioning on the support element 26 with respect to at least one direction 58 perpendicular to the axial direction 28. The receptacle 52 receives at least half of the total spring coils 48 of the spring element 46.

A spring-guiding means, or spring guide, 60 positions the spring element 46 on the slide 30 with respect to at least one direction 62 perpendicular to the axial direction 28. The spring-guiding means 60 is a component designed separately from the slide 30, in particular a pin 64, and is fastened, here riveted, thereto. The spring-guiding means 60 has an axial length 66 in the axial direction 28, proceeding from the slide 30 toward the support element 26, which is smaller than a minimum distance 68 between the slide 30 and the support element 26 and smaller than a minimum spring length 70 of the spring element 46. The minimum spring length 70 may be at the second axial position.

The spring-guiding means 60 and the spring element 46 overlap at least in sections in the axial direction 28. The spring-guiding means 60 is arranged inside an inner spring diameter 72 of the spring element 46. The pin 64 has a lateral surface 74 against which the spring coils 48 rest and thus ensures a defined contact position of the spring element 46 relative to the slide 30, in particular so that the spring element 46 is fixed in all directions perpendicular to the axial direction 28.

FIG. 2 shows a slide housing of a slide of the park lock device shown in FIG. 1. The slide housing 34 has two opposite lateral plates 76, which are connected to each other by transverse plates 78, which are also opposite each other. The spring-guiding means 60 is arranged on one transverse plate 78a and an actuator element for actuating the slide 30 engages on the other transverse plate 78b.

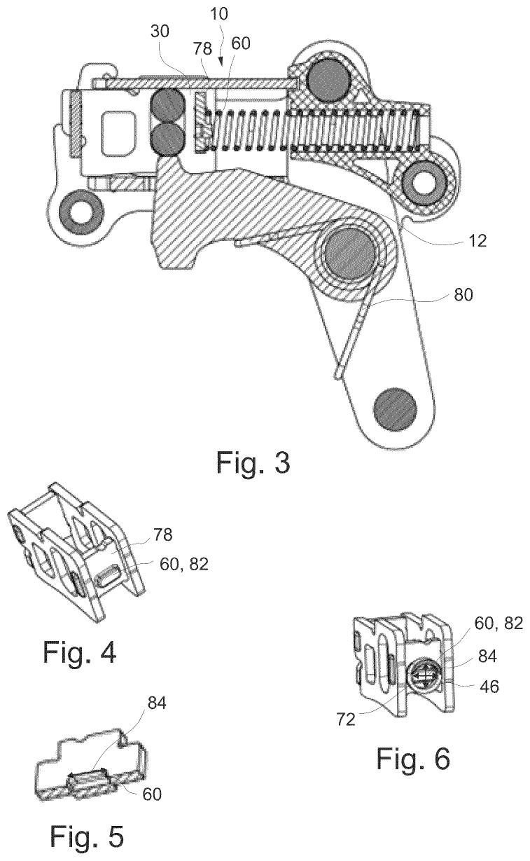

FIG. 3 shows a cross-section of a park lock device in a further embodiment. The park lock device 10 is constructed similarly to that shown in FIG. 1. The main differences will be described below. The return spring 80 is arranged as a torsion spring on the pawl 12 and causes a preload of the pawl 12 into the release position.

The spring-guiding means 60 is made in one piece with a transverse plate 78 of the slide 30.

FIG. 4 shows a slide housing of a slide of the park lock device shown in FIG. 3. The spring-guiding means 60 is made in one piece from the transverse plate 78 as a through-hole 82. The spring element can be pressed onto the spring-guiding means 60.

FIG. 5 shows a cross-section of a housing wall of the slide housing shown in FIG. 4. The spring-guiding means 60 has a width 84, such that the spring element with an inner spring diameter rests against the spring-guiding means 60 with or without play.

FIG. 6 shows the slide housing shown in FIG. 4 with a partially visible spring element. The spring-guiding means 60 is designed as a round or oval through-hole 82 onto which the spring element 46 with an inner spring diameter 72 is pressed. The spring-guiding means 60 may have a width 84 equal to or greater than the inner spring diameter 72.

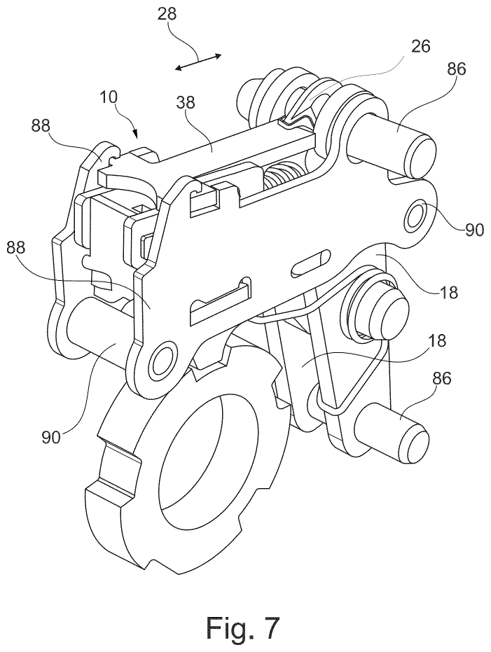

FIG. 7 shows a three-dimensional view of a park lock device in a further embodiment. The park lock device 10 includes a total of two reinforcing plates 18, which are supported on a transmission housing via two bolts 86. The slide is bordered by two lateral plates 88 which receive the support plate 38 on a side opposite the support element 26 in the axial direction 28.

A total of two sleeves 90 are pressed into the lateral plates 88, which keep the two lateral plates 88 at a distance and prevent the rollers from wandering out of the slide. The sleeves 90 each receive a screw for fastening the park lock device 10 to a transmission, in particular a transmission wall.

### REFERENCE NUMERALS

10 Park lock device
12 Pawl
14 Axis of rotation
16 Bolt
18 Reinforcing plate
20 Locking position
24 Pawl tooth
26 Support element
28 Axial direction
30 Slide
32 First axial position
34 Slide housing
36 Support roller
38 Support plate
40 Support roller
42 Further support roller
44 Outer contour
46 Spring element
48 Spring coil
50 Helical spring
52 Receptacle
54 Inner circumference
56 Outer spring diameter
58 Perpendicular direction
60 Spring-guiding means/spring guide
62 Perpendicular direction
64 Pin
66 Axial length
68 Minimum distance
70 Spring length
72 Inner spring diameter
74 Lateral surface
76 Lateral plate
78 Transverse plate
80 Return spring
82 Through-hole
84 Width
86 Bolt
88 Lateral plate
90 Sleeve

1. A park lock device comprising:
a pivotable pawl which can be pivoted between a locking position in which the pawl form-lockingly engages in a rotary component, and a release position in which the pawl is uncoupled from the rotary component,
a slide which can be moved relative to a support element in the axial direction such that an axial position is changed and which, in a first axial position, deflects the pawl into the locking position,
a spring element which is coupled, at one end, to the support element and, at the other end, to the slide and which applies a spring force to the slide when the slide is in at least one of its axial positions,
a spring guide which positions the spring element on the slide with respect to at least one direction perpendicular to the axial direction, wherein:
an axial length of the spring guide in the axial direction, proceeding from the slide toward the support element, is less than a minimum spring length of the spring element in the axial direction.

2. The park lock device according to claim 1, wherein the axial length of the spring guide is smaller than a minimum distance in the axial direction between the slide and the support element.

3. The park lock device according to claim 1, wherein the spring guide and the spring element overlap at least in sections in the axial direction.

4. The park lock device according to claim 1, wherein the spring element is designed as a helical spring having a plurality of spring coils.

5. The park lock device according to claim 1, wherein the spring guide is arranged inside an inner spring diameter of the spring element.

6. The park lock device according to claim 1, wherein the spring guide is arranged outside of an outer spring diameter of the spring element.

7. The park lock device according to claim 1, wherein the support element has a receptacle, on the inner circumference of which an outer spring diameter of the spring element bears for positioning on the support element with respect to at least one direction perpendicular to the axial direction.

8. The park lock device according to claim 7, wherein the receptacle accommodates at least half of the total spring coils of the spring element.

9. The park lock device according to claim 1, wherein the spring guide is a component designed separately from the slide and is fastened thereto.

10. The park lock device according to claim 1, wherein the spring guide is designed in one piece with the slide.

11. A park lock device, comprising:
a pivotable pawl, pivotable between a locking position in which the pivotable pawl is form-lockingly engaged in a rotary component, and a release position in which the pivotable pawl is uncoupled from the rotary component;
a support element;
a slide, axially movable relative to the support element between a first axial position in which the slide deflects the pivotable pawl into the locking position, and a second axial position;
a spring element:
comprising a minimum spring length;
arranged to provide a spring force to the slide when the slide is in the first axial position or the second axial position; and
coupled to the support element at one end and the slide at the other end; and
a spring guide arranged to position the spring element on the slide, the spring guide comprising a length less than the minimum spring length.

12. The park lock device of claim 11, further comprising a minimum distance between the slide and the support element, wherein the spring guide comprises a length less than the minimum distance.

13. The park lock device of claim 11, wherein the spring guide overlaps the spring element.

14. The park lock device of claim 11, wherein:
the spring element comprises an inner spring diameter; and
the spring guide is arranged inside the inner spring diameter.

15. The park lock device of claim 11, wherein:
the spring element comprises an outer spring diameter; and
the spring guide is arranged outside the outer spring diameter.

16. The park lock device of claim 11, wherein the spring element is a helical spring comprising a plurality of spring coils.

17. The park lock device of claim 16, wherein:
the support element comprises a receptacle with an inner circumference; and
the spring element comprises an outer spring diameter that bears on the inner circumference.

18. The park lock device of claim 17, wherein the receptacle accommodates at least half of the plurality of spring coils.

19. The park lock device of claim 11, wherein the spring guide is a separate component fastened to the slide.

20. The park lock device of claim 11, wherein the spring guide and the slide are formed as a single component.
